(19) United States
(12) Patent Application Publication
(10) Pub. No.: US 2026/0134453 A1
(43) Pub. Date: May 14, 2026

(54) METHOD OF PROVIDING INFORMATION AND APPARATUS FOR CARRYING OUT THE SAME

(71) Applicants: HYUNDAI MOTOR COMPANY, SEOUL (KR); KIA CORPORATION, SEOUL (KR)

(72) Inventor: So Young Eom, Hwaseong-si (KR)

(73) Assignees: HYUNDAI MOTOR COMPANY, SEOUL (KR); KIA CORPORATION, SEOUL (KR)

(21) Appl. No.: 19/231,347

(22) Filed: Jun. 6, 2025

(30) Foreign Application Priority Data
Nov. 13, 2024 (KR) 10-2024-0161185

(51) Int. Cl. G06Q 30/0251; G06Q 30/0207; G06Q 30/0242; G06Q 30/0273

(52) U.S. Cl. CPC G06Q 30/0265; G06Q 30/0207; G06Q 30/0245; G06Q 30/0271; G06Q 30/0273

(57) ABSTRACT

A method of providing information is disclosed. The method includes collecting, by a server, information about a business that seeks an advertisement for a service including a time restriction, determining an advertisement-target vehicle based on an occupant condition and a time condition provided in the collected information, and transferring the advertisement to the determined advertisement-target vehicle.

### CROSS-REFERENCE TO RELATED APPLICATION(S)

The present application claims priority to Korean Patent Application No. 10-2024-0161185, filed Nov. 13, 2024, the entire contents of which are incorporated herein for all purposes by this reference.

### TECHNICAL FIELD

The present disclosure relates to a method of providing information and an apparatus for performing the method. The method includes collecting, by a server, information about a business that seeks an advertisement for a service having a time restriction, determining an advertisement-target vehicle to which the advertisement is transferred based on an occupant condition and a time condition provided in the collected information, and transferring the advertisement to the determined advertisement-target vehicle.

### BACKGROUND

A navigation system mounted in a vehicle may display the current location and driving direction of the vehicle through an information output device using information received from a global positioning system (GPS) satellite. When a destination is input into the navigation system, the navigation system displays on its screen the route from the current location, the distance to the destination, the estimated travel time, and other relevant information.

This function of displaying the route also provides more optimized route information using real-time traffic information. Moreover, the navigation system also provides a function of reproducing multimedia content.

In recent years, there has been a trend for an occupant in a vehicle to stay in the vehicle for longer time periods. For this reason, a feature to enhance user convenience using the navigation system, such as providing an advertisement for a business may be useful.

Accordingly, various forms of vehicle-specific advertisements are in continuous demand. Moreover, a method for (e.g., effectively) transferring an advertisement (for example, an advertisement when a business has a no-show situation) including a time restriction to the occupant in the vehicle may be useful. The method disclosed herein can enhance the effectiveness of the advertisement and maximize profit creation.

The foregoing background is intended to aid in understanding the background of the present disclosure and therefore should not be interpreted as an admission that the present disclosure falls within the purview of the prior art that is already known to a person of ordinary skill in the art.

### SUMMARY

An object of the present disclosure is to provide a method of providing information and an apparatus for performing the method. The method includes collecting, by a server, information about a business that seeks an advertisement for a service including a time restriction, determining an advertisement-target vehicle to which the advertisement is transferred, wherein the business has an occupant condition and a time condition based on the collected information, and transferring the advertisement to the determined advertisement-target vehicle.

The present disclosure is not limited to the above-mentioned object. From the following description, additional objects may be understood by a person of ordinary skill in the art to which the present disclosure pertains.

In order to accomplish the above-mentioned object, according to one aspect of the present disclosure, there is provided a method of providing information. The method includes collecting, by a server, information about a business that seeks an advertisement for a service including a time restriction, determining an advertisement-target vehicle to which the advertisement is transferred based on an occupant condition and a time condition provided in the collected information, and transferring the advertisement to the determined advertisement-target vehicle.

In one embodiment, in the method, the advertisement for the service including the time restriction may include an advertisement based on a no-show situation.

In one embodiment, in the method, the collecting of the information may include receiving, by the server, information about the business, as an input, from a terminal of the business, based on preset business information items.

In one embodiment, in the method, the determining of the advertisement-target vehicle may include determining an age bracket for occupants based on information about whether or not a buggy seat is mounted, weights of occupants, and measurement data obtained by (e.g., both) an internal camera and a microphone within the vehicle. The information, the weights, and the measurement data is received from the vehicle that is provided to communicate with the server.

In one embodiment, in the method, the determining of the advertisement-target vehicle may include determining the number of occupants based on whether (e.g., or not) a plurality of vehicles, provided to communicate with the server, drive in groups.

In one embodiment, in the method, the time condition may include the time restriction and the estimated time of arrival of the vehicle that is provided to communicate with the server.

In one embodiment, in the method, the determining of the advertisement-target vehicle may include determining the urgency of the advertisement based on the time restriction and a preset time reference.

In one embodiment, in the method, the determining of the advertisement-target vehicle may include determining a discount rate for the service based on the urgency of the advertisement.

In one embodiment, in the method, the transferring of the advertisement may include transferring the advertisement in such a manner that the advertisement is displayed in the form of a brand pin on an information output device of the advertisement-target vehicle.

In one embodiment, in the method, the brand pin may include at least one of the location or discount rate of the business.

In one embodiment, the method may further include determining the unit price of the advertisement.

In one embodiment, the method may further include determining under the occupant condition whether or not the unit price of the advertisement is increased by applying an extra charge.

In one embodiment, the method may further include collecting and storing a response of an occupant to the advertisement.

In order to accomplish the above-mentioned object, according to another aspect of the present disclosure, a server is provided. The server includes a controller that collects information about a business that seeks an advertisement for a service including a time restriction and determines an advertisement-target vehicle to which the advertisement is transferred based on an occupant condition and a time condition provided in the collected information, and a communication unit through which the advertisement is transferred to the determined advertisement-target vehicle.

In one embodiment, in the server, the advertisement for the service including the time restriction may include an advertisement based on a no-show situation.

In one embodiment, in the server, the occupant condition may include at least one of an age bracket for occupants in a vehicle or the number of occupants.

In one embodiment, in the server, the time condition may include the time restriction and the estimated time of arrival of the vehicle that is provided to communicate with the server.

In one embodiment, in the server, the controller may determine the unit price of the advertisement.

In one embodiment, in the server, the controller may collect and store a response of an occupant in a vehicle to the advertisement.

According to the present disclosure, with the method of providing information and the apparatus for performing the method, the advertisement can be (e.g., effectively) transferred (e.g., presented) to the occupant in the vehicle. Thus, the effectiveness of the advertisement can be enhanced, and profit creation can be maximized.

The present disclosure is not limited to the above-mentioned effect. From the following description, additional effects may be understood by a person of ordinary skill in the art to which the present disclosure pertains.

### BRIEF DESCRIPTION OF THE DRAWINGS

FIG. 1 is a flowchart illustrating a method of providing information according to one embodiment of the present disclosure.

FIG. 2 is a flowchart illustrating a step of determining an advertisement-target vehicle according to one embodiment.

FIG. 3 is a flowchart illustrating a step of extracting a list of vehicles having a time condition according to one embodiment.

FIG. 4 is a diagram illustrating a vehicle, a server, and a terminal of a business according to one embodiment.

FIG. 5 is a view illustrating an advertisement according to one embodiment output through an information output device of the vehicle.

### DETAILED DESCRIPTION

When describing embodiments of the present disclosure in the present specification, detailed descriptions of related technologies may be omitted if it would obscure the nature and gist of the present disclosure. In addition, the accompanying drawings are provided to facilitate understanding of the embodiments of the present disclosure in the present specification. It should be understood that the technical idea of the present disclosure in the present specification is not limited by the accompanying drawings. Furthermore, it should be understood that any alteration or equivalent of, or any substitute for, a constituent element according to the embodiment of the present disclosure, as long as it falls within the scope of the technical idea of the present disclosure, is included within the scope of the present disclosure. The description hereinafter of the present disclosure is not intended to limit the present disclosure to the forms as described or the specific fields. It should be considered that various alternative embodiments of, and modifications to, the present disclosure are also possible from the present specification. It would be understandable to a person of ordinary skill in the art to which the present disclosure pertains that the contents, forms, and details of the present disclosure may be subject to change.

The contents of the present disclosure are described with reference to specific embodiments. However, various embodiments of the present disclosure may be modified or implemented in various different ways in a manner that is understandable by a person of ordinary skill in the art to which the present disclosure pertains, as long as they do not depart from the technical idea and scope of the present disclosure. Therefore, the description hereinafter should be considered to be exemplary, and teaches a person of ordinary skill in the art to which the present disclosure pertains about methods of creating and using various embodiments. It will be understood that the forms described in the present specification with reference to the drawings are regarded as representative embodiments. Equivalent elements or materials, and equivalent processes or steps may be replaced with those representatively illustrated and described according to the present disclosure. The terms “including,” “comprising,” “incorporating,” “consisting of,” “having,” “be,” and the like, which are used to describe the present disclosure, should be interpreted as permitting the addition of items, constituent elements, or components that are not expressed in a non-exclusive manner, that is, in a definite manner. In addition, a noun in singular form should be interpreted as having the same meaning as when used in its plural form.

In addition, various embodiments of the present disclosure in the present specification should be regarded as exemplary and explanatory and should not be interpreted to limit the contents of the present disclosure. The terms related to joining (for example, attached, affixed, coupled, connected, and the like) are used to aid understanding of the present disclosure and are not intended to limit the position, direction, or use of a constituent element, or to limit any method according to the present disclosure in the present specification. Therefore, any term related to joining, when referred to, should be broadly interpreted. Moreover, when the term related to joining is referred to, it should not be construed that two or more constituent elements are connected directly to each other. Additionally, for example, the ordinal numbers first, second, third, and so forth, the ordinal adjectives “primary,” and “secondary,” the qualitative adjectives “principal,” “subordinate,” or the terms related to numbers should be regarded as identifiers to aid understanding of various constituent elements or forms of the present disclosure, or of alterations or modifications thereto. These terms are not intended to impose any limitation to arbitrary constituent elements and forms of the present disclosure, or to alterations or modifications thereto, or to the order of these constituent elements or the preference for one element over another. That is, these terms may be used to describe various constituent elements, but do not limit these constituent elements. These terms are used for the purpose of distinguishing one constituent element from another.

The terms “module” and “unit” are hereinafter interchangeably or individually used to refer to a constituent element for convenience in description in the present specification. Therefore, they are not intended by themselves to convey different meanings or to depict different functions.

It should be understood that a constituent element, when referred to as “being connected to” or “having access to” a different constituent element, may also be directly connected to or have direct access to the different constituent element or may also be connected to or have access to the different constituent element with a third constituent element in between. Conversely, it should be understood that a constituent element, when referred to as “directly connected to” or “having direct access to” a different constituent element, may be connected to or have access to the different constituent element without a third constituent element in between.

In addition, the term unit or control unit, which constitutes the name of a constituent element, is widely used to name a controller for controlling a specific function of a vehicle and is not intended to denote a generic function unit.

A controller may include a communication device that communicates with another controller or a sensor to control functions assigned to the controller, a memory in which an operating system, logic commands, input and output information, and the like are stored, and one or more processors that perform determination, computation, decision-making, and other operations that are used to control the assigned functions.

An arbitrary number of components or various components in any one of the configurations described in the present specification may be included in the scope of the present disclosure described in the present specification. The components may each include an arbitrary combination of feature units described in the present specification and be arranged in an arbitrary one of the various configurations described in the present specification. The concepts of the uses and operations of the components according to the present disclosure, as well as of the structures and arrangements of the components, may apply to embodiments, each including an arbitrary number of arbitrary combinations, as well as to specific embodiments described in the present specification. Embodiments, each including various feature units in various arrangements, are described below with reference to the drawings.

Various embodiments of the present disclosure in the present specification will be described in detail below with reference to the accompanying drawings. Regardless of figure numbers, the same or similar constituent elements are given the same reference number, and descriptions thereof may not be repeated.

In a case where a customer who made a reservation cancels the reservation close to the reservation start time, businesses that are scheduled to provide a service to a predetermined number of persons during the reservation time span face difficulties securing new reservations over the canceled reservation time span. Particularly, in a case where food is cooked and prepared or where a business rents a meeting space (e.g., a limited number of times, such as two times), the reservation cancellation may cause monetary damage.

Accordingly, an advertisement for the business with the canceled reservation is transferred to a vehicle that can arrive within the canceled reservation time span or a vehicle that has the occupants with a user (e.g., needs) for a service identical or similar to the canceled service. Thus, a method of maximizing benefits for a business and a customer and an apparatus for performing the method may be useful.

Accordingly, the present disclosure provides a method of providing information and an apparatus for performing the method. In the method of providing information, a server collects information about a business that seeks an advertisement for a service including a time restriction, determines an advertisement-target vehicle to which the advertisement is transferred based on an occupant condition and a time condition provided in (e.g., based on) the collected information, and transfers the advertisement to the determined advertisement-target vehicle.

In one embodiment, a vehicle 100 may include a communication device 110, a controller 120, an information output device 130, and a collection device 140, which may be considered as constituent elements. In other embodiments, the vehicle 100 may omit one or more constituent elements or add one or more constituent elements.

Various elements are described below.

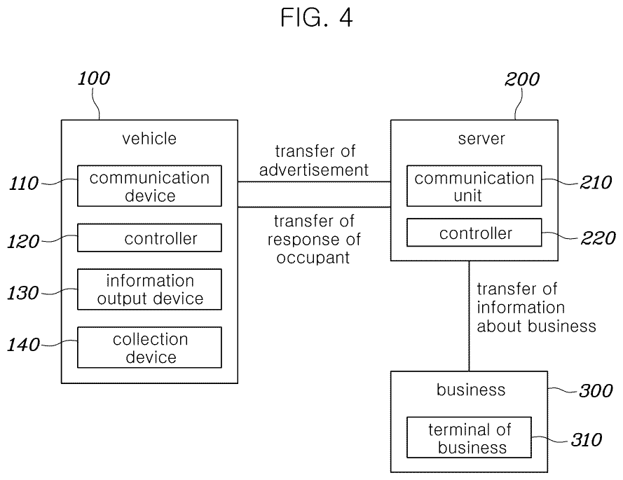

With reference to FIG. 4, in one embodiment, under the control of the controller 120, through the communication device 110, an advertisement may be transferred from the server 200 to the controller 120. Furthermore, through the communication device 110, an age bracket for an occupant, information about the number of occupants, the current location and driving speed of the vehicle 100, destination information, and a response of an occupant to the advertisement transferred from the server 200 may be transferred to the server 200.

In one embodiment, for external communication, the communication device 110 may include a wireless communication module for Wi-Fi, Bluetooth, or cellular networks. However, this is an example configuration, and the communication device 110 is not limited thereto.

In one embodiment, by controlling the communication device 110, the controller 120 may receive the advertisement from the server 200 and transfer to the server 200 an age bracket for an occupant, information about the number of occupants, the current location and driving speed of the vehicle 100, destination information, and a response of an occupant to the advertisement. By controlling the information output device 130, the controller 120 may enable the advertisement transferred from the server 200 to be output to the occupants of the vehicle 100. By controlling the collection device 140, the controller 120 may collect a response of an occupant to the advertisement, an age bracket for an occupant, and information about the number of occupants.

In one embodiment, the controller 120 may be realized as a functional unit of an audio/video/navigation (AVN) system provided in the vehicle 100. However, this configuration is an example, and the controller 120 is not limited thereto. More specifically, the controller 120 may also be separate from the AVN system and may be provided as two or more different controllers, with the controller function distributed among them.

In one embodiment, under the control of the controller 120, the information output device 130 may output the advertisement transferred from the server 200, using a technique that provides both visual and auditory recognition.

In one embodiment, the information output device 130 may include at least one of a display device, a speaker, and/or a head-up display.

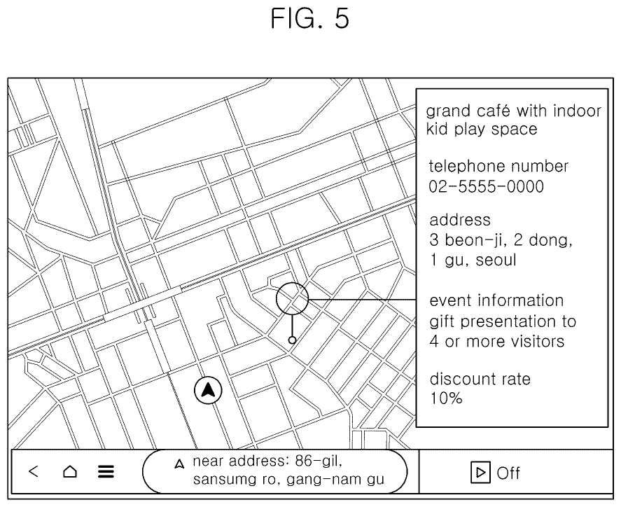

Under the control of the controller 120, the information output device may output the advertisement in a manner that is displayed in the form of a brand pin on the display device, and the brand pin may include at least one of the location of a business or discount rate of the business. The display of the advertisement on the display unit will be described in detail below with reference to FIG. 5.

In one embodiment, the collection device 140 may collect information about an occupant in the vehicle 100 or a response of an occupant in the vehicle 100 to the advertisement transferred from the server 200 and transfer the collected information or response to the controller 120.

In one embodiment, the collection device 140 may include a buggy seat detection sensor, a camera, a motion recognition sensor, a touch screen, a pressure detection sensor, a microphone, and/or similar components. However, this is an example configuration, and the collection device 140 is not limited thereto.

Elements of the server 200 are described below.

With reference to FIG. 4, in one embodiment, under the control of the controller 220, through the communication unit 210, the advertisement may be transferred to the vehicle 100, and an age bracket for an occupant, information about the number of occupants, the current location and driving speed of the vehicle 100, destination information, and a response of an occupant to the advertisement may be transferred from the vehicle 100 to the controller 220. Then, through the communication unit 210, information about a business 300 that seeks an advertisement for a service including a time restriction may be received from a terminal of the business 310.

In one embodiment, by controlling the communication unit 210, the controller 220 may transfer the advertisement to the vehicle 100, and receive, from the vehicle 100, information about an occupant, the current location and driving speed of the vehicle 100, destination information, and a response of an occupant to the advertisement. Then, by controlling the communication unit 210, the controller 220 may receive from the terminal of the business 310 the information about the business 300 that seeks the advertisement for the service including a time restriction and may collect the received information.

In one embodiment, the controller 220 may determine the advertisement-target vehicle to which the advertisement is transferred, having the occupant condition and the time condition based on the collected information, determine the urgency of the advertisement, and collect and store the unit price of the advertisement and the response of the occupant to the advertisement.

The operational process of the vehicle 100 according to one embodiment, and the operational process of the server 200 are described in detail below.

Except for the unique function of the communication unit 210, it would be understandable to a person of ordinary skill in the art, as described below, that the server 200 may operate under the determination and control of the controller 220.

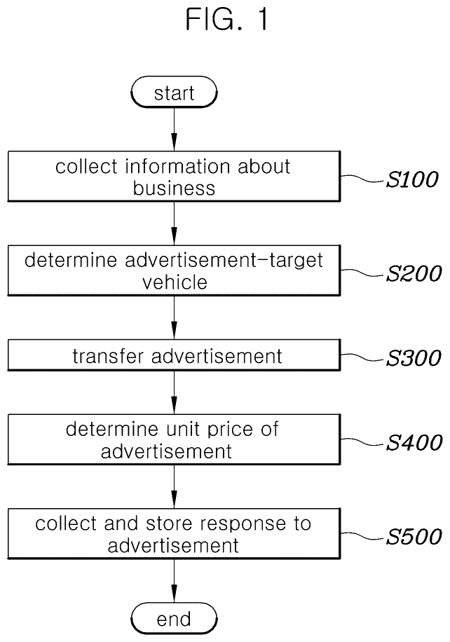

With reference to FIG. 1, in one embodiment, the server 200 may collect the information about the business 300 that seeks the advertisement including a time restriction. More specifically, the server 200 may receive the information about the business 300, as an input, from the terminal of the business 310 based on preset business information items (S100).

The advertisement for the service including a time restriction may be an advertisement based on a no-show situation. In this case, the service including a time restriction may refer to a service that may be affected when a customer who made a reservation with the business 300 either does not show up or fails to use the service without prior notice.

The time restriction may refer to a restriction on a specific point in time or the time, at or during, which a service is (e.g., required) to be provided, as is the case with a reservation time span (e.g., time frame) for a reserved service.

The preset business information items may include a specific age bracket targeted by the service including a time restriction, or the minimum number of persons to which a service is to be provided.

For example, in a case where the business 300 is a restaurant, the preset business information items may include at least one of the type of food that was pre-ordered and the type of food to be served, the quantity of food, the price of food, the number of persons, and/or the reservation time span.

For example, in a case where the business 300, such as a café with an indoor kid play space, targets a customer in a specific age bracket, the preset business information items may include at least one of a customer (for example, an infant or a child) in the targeted age bracket, the minimum number of persons, and/or the reservation time span.

The (e.g., fundamental) information about the name, location, business type, service to be provided, price, and/or similar details of the business 300 may be pre-registered with the server 200.

In one embodiment, the server 200 may determine whether or not the advertisement-target vehicle to which the advertisement is transferred based on the occupant condition and the time condition provided in (e.g., based on) the collected information (S200).

The server 200 may (e.g., simultaneously) determine the advertisement-target vehicle under the occupant condition and the advertisement-target vehicle under the time condition and may also first determine one advertisement-target vehicle and determine another advertisement-target vehicle later.

In addition, the occupant condition may include at least one of the age bracket for occupants in the vehicle 100 or the number of occupants. The time condition may include the time restriction and the estimated time of arrival of the vehicle 100 that is provided to communicate with the server 200.

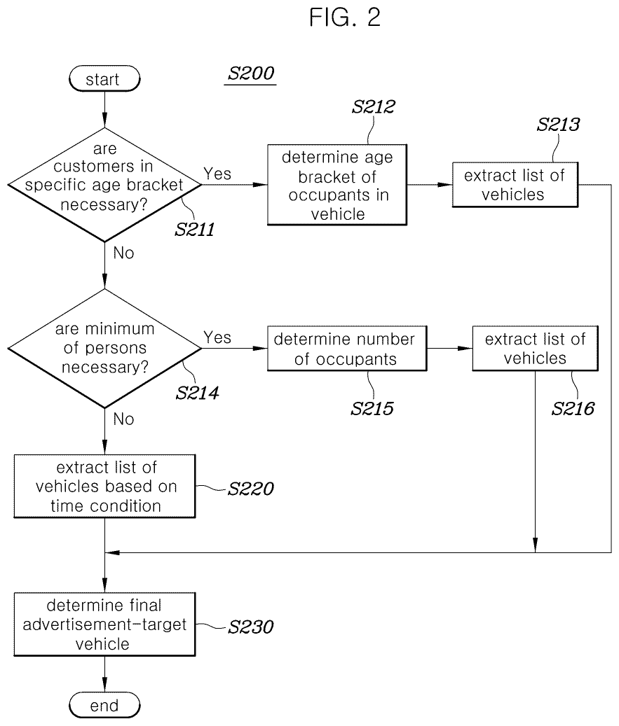

According to one embodiment of the present disclosure, a step of determining the advertisement-target vehicle is described below with reference to FIG. 2 (S200). However, this step is an example, and the present disclosure is not limited to the following description.

The server 200 may determine whether or not the business 300 targets customers in a specific age bracket (S211).

In a case where the business 300 targets customers in a specific age bracket, the server 200 may recognize the age bracket for occupants riding in the vehicle 100 (S212). For example, the age bracket for occupants may be determined based on information about whether or not a buggy seat is mounted, the weights of occupants, and measurement data obtained by both an internal camera and a microphone within the vehicle 100. The information, the weights, and the measurement data are received from the vehicle 100 that is provided to communicate with the server 200. It may be determined whether or not occupants are in a specific age bracket targeted by the business 300 ride.

Subsequently, the server 200 may extract a list of the vehicles 100, with occupants in a targeted specific age bracket being determined as riding in each of the vehicles 100 (S213).

In a case where it is determined that occupants in a specific age bracket are not used in determining the advertisement-target vehicle, the server 200 may determine whether or not the minimum number of persons (e.g., necessary) for the business 300 to provide a service is available (S214).

In a case where the minimum number of occupants (e.g., necessary) for the business 300 to provide a service is available, the server 200 may determine the number of occupants riding in the vehicle 100 (S215).

More specifically, the server 200 may determine the number of occupants based on whether or not a plurality of vehicles 100, sharing the same destinations or stopovers, drive in groups. Furthermore, in a case where a plurality of vehicles 100 with the same destination and stopover drive in groups, the server 200 may determine the total number of occupants who ride in the plurality of vehicles 100 that drive in groups, as the number of occupants.

Subsequently, the server 200 may extract a list of one or more vehicles 100, with the minimum number of persons or more (e.g., necessary) to provide a service being determined as riding in the one or more vehicles 100 (S216).

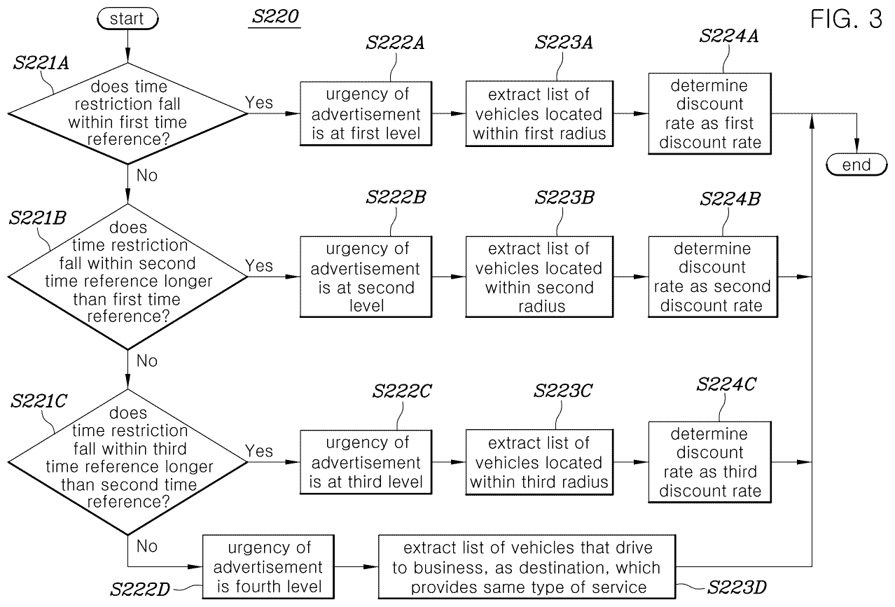

In a case where the number of persons (e.g., necessary) for the business 300 to provide a service is not available, the server 200 may extract a list of vehicles 100 under the time condition (S220). The extraction of the list of vehicles 100 will be described below with reference to FIG. 3.

Subsequently, the server 200 may determine the final advertisement-target vehicle based on the extracted list of vehicles 100 (S230).

According to the present disclosure, step S220 of extracting the list of vehicles 100 under the time condition is described below with reference to FIG. 3. However, step S220 is an example, and the present disclosure is not limited to the following description.

With reference to FIG. 3, the server 200 may determine the urgency of the advertisement based on the time restriction of a service and a preset time reference.

More specifically, the server 200 may determine whether or not the time restriction of a service falls within a first time reference (S221A). In a case where the time restriction of a service falls within the first time reference, the server 200 may determine the urgency of the advertisement to be at the first level (S222A).

The server 200 may determine whether or not the time restriction falls within a second time reference, wherein the second time reference is longer than the first time reference (S221B). In a case where the time restriction falls within the second time reference, the server 200 may determine the urgency of the advertisement to be at the second level (S222B).

The server 200 may determine whether or not the time restriction falls within a third time reference, wherein the third time reference is longer than the second time reference (S221C). In a case where the time restriction falls within the third time reference, the server 200 may determine the urgency of the advertisement to be at the third level (S222C).

In a case where the time restriction exceeds the third time reference, the server 200 may determine the urgency of the advertisement to be at the fourth level (S222D).

For example, the first time reference may refer to 15 minutes, the second time reference may refer to 30 minutes, and the third time reference may refer to one hour.

Subsequently, the server 200 may extract a list of vehicles 100 located within a preset radius based on the urgency of the advertisement (S223).

More specifically, in a case where the urgency of the advertisement is determined to be at the first level, the server 200 may extract a list of vehicles 100 located within a first radius from the location of the business 300 (S223A).

In a case where the urgency of the advertisement is determined to be at the second level, the server 200 may extract a list of vehicles 100 located within a second radius from the location of the business 300 (S223B).

In a case where the urgency of the advertisement is determined to be at the third level, the server 200 may extract a list of vehicles 100 located within a third radius from the location of the business 300 (S223C).

In a case where the urgency of the advertisement is determined to be at the fourth level, the server 200 may extract a list of vehicles 100 that share the same destinations or stopovers as the business 300, such as destinations or stopovers which provide the same type of service as the service provided with the time restriction (S223D).

For example, the first radius may refer to a distance to the business 300, over which the vehicle 100 drives within an estimated 15 minutes. The second radius may refer to a distance to the business 300, over which the vehicle 100 drives within an estimated 30 minutes. The third radius may refer to a distance to the business 300, over which the vehicle 100 drives within an estimated one hour.

In addition, the server 200 may determine the discount rate for a service, depending on the urgency of the advertisement (S224).

More specifically, in a case where the urgency of the advertisement is at the first level, the server 200 may determine the discount rate for a service as a first discount rate (S224A). In a case where the urgency of the advertisement is at the second level, the server 200 may determine the discount rate for a service as a second discount rate (S224B). In a case where the urgency of the advertisement is at the third level, the server 200 may determine the discount rate for a service as a third discount rate (S224C).

For example, the first discount rate may be 30%, the second discount rate may be 20%, and the third discount rate may be 10%.

With reference to FIG. 1, the server 200 may transfer the advertisement to the advertisement-target vehicle (S300). More specifically, the server 200 may transfer the advertisement in such a manner that the advertisement is displayed in the form of a brand pin on the information output device 130 of the advertisement-target vehicle.

The brand pin may include at least one of the location or the discount rate of the business 300.

With reference to FIG. 5, the brand pin may be in the shape of a pin displayed on a specific position on a map and include the location, and/or telephone number, further the pin may include a contact point, address, event information, and discount rate information of the business 300.

With reference to FIG. 1, in one embodiment, the server 200 may determine the unit price of the advertisement. More particularly, the server 200 may determine (e.g., under the occupant condition) whether or not the unit price of the advertisement is increased by applying an extra charge (S400).

Specifically, in a case where the advertisement-target vehicle is considered to be determined (e.g., under the occupant condition), the server 200 may determine an increase in the unit price of the advertisement by applying extra charge. The charge may apply when the age bracket for target occupants and/or or the minimum number of persons for the service is included in the information about the business 300.

In one embodiment, the server 200 may determine the unit price of the advertisement on a cost-per-mile (CPM) basis that counts an impression each time the advertisement is displayed. In a case where the advertisement is transferred to the vehicle 100 and where an occupant in the vehicle 100 who views the advertisement uses a service provided by the business 300 through the advertisement, the server 200 may determine on the unit price on a cost-per-click (CPC) basis that counts the number of clicks on the advertisement.

In one embodiment, the server 200 may collect and store a response of an occupant to the advertisement (S500).

In one embodiment, after the advertisement is transferred to the vehicle 100, the response of the occupant in the vehicle 100 to the advertisement may be collected through the collection device 140 of the vehicle 100, and the collected response may be transferred to the server 200. The transferred response of the occupant to the advertisement may be stored in the server 200. Thereafter, the response of the occupant may be reflected in providing the advertisement to occupants and determining the advertisement-target vehicle.

As described with reference to FIG. 1, the unit price of the advertisement is first determined, and then, the response to the advertisement is collected and stored. This sequence is for convenience in description. The determination of the unit price of the advertisement and the collection and storing of the response to the advertisement may be simultaneously performed. Alternatively, the determination of the unit price of the advertisement may be first performed and the collection and storing of the response to the advertisement may be later performed, and vice versa.

The specific embodiments of the present disclosure are described above with every feature thereof being illustrated in the drawings. However, it may be obvious to a person of ordinary skill in the art to which the present pertains that various modifications and alterations are possibly made to the embodiments of the present disclosure without departing from the technical idea of the present disclosure that is set forth in the following claims.

What is claimed is:

1. A method of providing information, the method comprising:
collecting, by a server, information about a business, wherein the business seeks to provide an advertisement for a service including a time restriction;
determining an advertisement target vehicle based on an occupant condition and a time condition provided in the collected information; and
transferring the advertisement to the determined target vehicle to display the advertisement.

2. The method of claim 1, wherein the advertisement is based on a no-show situation.

3. The method of claim 1, wherein collecting the information includes:
receiving, by the server, the information about the business as an input from a terminal of the business, wherein the input is based on preset business information items.

4. The method of claim 1, wherein the occupant condition includes at least one of an age bracket for occupants in a vehicle or a number of occupants.

5. The method of claim 4, wherein the determining the advertisement target vehicle includes:
determining an age bracket for the occupants based on information about whether a buggy seat is mounted in the vehicle, weights of occupants, and measurement data obtained from an internal camera and a microphone within the vehicle, wherein the information, the weights, and the measurement data is received by the server from the vehicle.

6. The method of claim 4, wherein determining the advertisement target vehicle includes:
determining the number of occupants based on whether a plurality of vehicles, provided to communicate with the server, drive in groups.

7. The method of claim 1, wherein the time condition includes the time restriction and an estimated time of arrival of the vehicle, wherein the vehicle is provided to communicate with the server.

8. The method of claim 7, wherein determining the advertisement target vehicle includes:
determining urgency of the advertisement based on the time restriction and a preset time reference.

9. The method of claim 8, wherein determining the advertisement target vehicle includes:
determining a discount rate for the service based on the urgency of the advertisement.

10. The method of claim 1, wherein transferring the advertisement includes:
transferring the advertisement to the vehicle such that the advertisement is displayed in the form of a brand pin on an information output device of the vehicle.

11. The method of claim 10, wherein the brand pin includes at least one of a location of the business or a discount rate of the business.

12. The method of claim 1, the method further comprising:
determining a unit price of the advertisement.

13. The method of claim 12, the method further comprising:
determining whether the unit price of the advertisement is increased by applying an extra charge.

14. The method of claim 1, the method further comprising:
collecting and storing a response of an occupant to the advertisement.

15. A server comprising:
a controller that
collects information about a business that seeks an advertisement for a service including a time restriction and
determines an advertisement target vehicle based on an occupant condition and a time condition provided in the collected information; and
a communication unit through which the advertisement is transferred to the determined advertisement target vehicle and the advertisement target vehicle displays the advertisement.

16. The server of claim 15, wherein the advertisement for the service is based on a no-show situation.

17. The server of claim 15, wherein the occupant condition includes at least one of an age bracket for occupants in a vehicle or a number of occupants.

18. The server of claim 15, wherein the time condition includes the time restriction and an estimated time of arrival of the vehicle that is provided to communicate with the server.

19. The server of claim 15, wherein the controller determines a unit price of the advertisement.

20. The server of claim 15, wherein the controller collects and stores a response of an occupant in a vehicle to the advertisement.
